(19) United States
(12) Patent Application Publication
(10) Pub. No.: US 2007/0131105 A1
(43) Pub. Date: Jun. 14, 2007

(54) Supply line

(76) Inventors: Friedrich Wilhelm Dannehl, Hagen (DE); Werner Reinelt, Bochum (DE)

Correspondence Address: BAKER & MCKENZIE LLP, 1114 AVENUE OF THE AMERICAS, NEW YORK, NY, 10036, US

(21) Appl. No.: 11/548,936

(22) Filed: Oct. 12, 2006

(30) Foreign Application Priority Data
Oct. 13, 2005 (DE) 20 2005 016207.8

(51) Int. Cl. F15B 13/04

(52) U.S. Cl. 91/418

(57) ABSTRACT

A supply line for connecting a hydraulic advancing support to a hydraulic supply system led along a conveyor is disclosed. The supply line includes a feed connection connectable to the supply system and an advancing support connection located a predetermined distance from the feed connection. A piston arrangement is located within a cylinder tube, and an inner duct having a variable length connects the feed connection and the advancing support connection.

The invention relates to a supply line for connecting a hydraulic advancing support to a hydraulic supply system led along a conveyor, with a feed connection connectable on the conveyor side to the supply system and with an advancing support connection which is arranged so as to be spaced apart from the feed connection and which is connected to the feed connection via an inner duct.

It is known from DE 1 091 063 A1 to design the bushing cylinders, by means of which support units to an advancing support are connected to a conveyor, as hydraulic connections, in order to avoid separate supply lines between the advancing support and the supply line. So that the bushing cylinders and hydraulic connections of the support units can be connected conductively to the supply system led along the conveyor, additional inner ducts must be arranged in the piston rods of the bushing cylinders, which necessitates a considerable increase in the outlay in manufacturing terms and makes it necessary to manufacture the piston rods with larger cross section, since only then can these receive the inner ducts and at the same time withstand the mechanical loads occurring during the advance. Furthermore, in this system, a control of the individual hydraulic consumers of the support units which is independent of the respective load state of the bushing cylinder is not possible. The hydraulic connection of the advancing support to the supply system by means of the bushing cylinders has proved a disadvantage, and therefore modern electro-hydraulically controllable support units are connected to the supply system via an external supply line.

DE 29 09 165 C3 discloses a supply line in the form of a bridge member which is arranged between two support units and which is connected at its conveyor-side end to a supply system via a feed connection and is fastened to the conveyor in an articulated manner by means of a holding device. At the other end, the bridge member is connected to the adjacent support units by means of two advancing support connections. The support units are connected to the bridge member via hoses and, during an advancing operation, move parallel along the bridge member, with the result that the hoses and the advancing support connections may be subjected to load. Since the bridge member is connected to the conveyor in an articulated manner, said bridge member may tilt during an advancing operation of the support units.

The object of the invention is to improve the supply lines, known from the prior art, for connecting an advancing support to a supply system and to reduce a load on the advancing support connection and on the hoses connected to the latter.

The object is achieved, according to the invention, by means of a cylinder tube and a piston arrangement guided telescopically therein, the interaction of which forms a telescopic inner duct of variable length. One advantage of the invention is that, during the advance of the support units, the current length of the supply line can be adapted to the distance between the conveyor and the support unit by power actuation or passively by means of the telescopic guide of the piston arrangement in the cylinder tube. Furthermore, individual hydraulic consumers of the support units can be controlled independently of the load state of the bushing cylinders. So that the supply line adapts its current length to the distance between the conveyor and support unit at any time, it is expedient that the supply line is preferably releasably fastened, at one end, to the conveyor and, at the other end, to the advancing support.

The piston arrangement displaceable in the cylinder tube preferably consists of a solid piston rod and of a hollow piston tube connected in series to the piston rod. The piston tube may have at one end an end piece which is provided with an external thread and which can be screwed to an internal thread in a piston head of the piston rod. The outside diameter of the piston rod is preferably smaller than the inside diameter of the cylinder tube. The annular gap thereby formed between the cylinder tube and piston rod then forms a portion of the inner duct. The tube cavity of the piston tube forms a further portion of the inner duct which issues at least with a connecting port into the annular gap. Depending on the push-out state, the inner duct then extends via the tube cavity of the piston tube through the connecting port and along the annular gap around the piston rod.

The at least one advancing support connection is preferably arranged essentially centrally between the two ends of the cylinder tube and expediently issues into the annular gap between the cylinder tube and the piston rod. The supply line preferably has two advancing support connections which may consist of two nipples which are arranged laterally and/or at the same height on the cylinder tube and which issue into the annular gap. The advancing support connections then form adjacent support connections and the supply line is arranged between two support units. It is particularly advantageous in this case if the piston tube and the piston rod are of approximately equal length, so that the supply line can be telescoped at most approximately by the amount of the length of the piston rod.

Expediently, the piston rod and the piston tube are provided in each case with a guide bush and with a seal, by means of which the piston arrangement is guided in the cylinder tube. These expediently delimit the annular gap. One guide bush having the first seal is preferably arranged in the vicinity of the end piece of the piston tube with which the piston tube is connected to the piston head of the piston rod, and the other guide bush having the second seal is preferably arranged at the free end of the piston rod which is remote from the piston tube.

In an advantageous refinement of the invention, the cylinder tube is closed at the conveyor-side end by means of a guide sleeve surrounding the piston tube. The guide sleeve may in this case protect the interior of the cylinder tube against the ingress of dirt, water, etc. The guide sleeve may preferably have inserted or integrated into it a lubricating nipple, via which a lubrication of the piston tube guide can be brought about, in order to allow an easy sliding of the piston tube in the guide sleeve. Further, the guide sleeve may have inserted into it a stripping ring which bears against the outer circumference of the piston tube and which, when that part of the piston tube which projects out of the cylinder tube is retracted, can strip off dirt or fine coal or the like on the piston tube. The guide sleeve may preferably be provided with a venting bore which runs essentially axially with respect to the piston arrangement and in which a filter is preferably further arranged. The advantage of this is that, during the retraction and extension of the piston arrangement, the air located between the piston tube and the cylinder tube can not only escape or be discharged, but is at the same time purified by means of the filter.

The feed connection is preferably formed on an angle cuff in which that end of the piston tube which projects out of the cylinder tube is fastened so as to be sealed off. The expediently upwardly pointing feed connection can thus be connected in an assembly-friendly manner to a longwall line of the supply system. A first holding device for connection to the conveyor is preferably arranged on the angle cuff, and a second holding device for connection to the advancing support is preferably arranged at the end of the cylinder tube which lies opposite the angle cuff. The advantage of this is that, during the advance of the advancing support, the forces acting on the supply line are introduced directly into the holding devices of preferably high-strength design, and the advancing support connection or advancing support connections and the feed connection are not subjected to load.

Further advantages and refinements of the invention may be gathered from the following description of the exemplary embodiment of a supply line according to the invention, as shown in the drawing, in which:

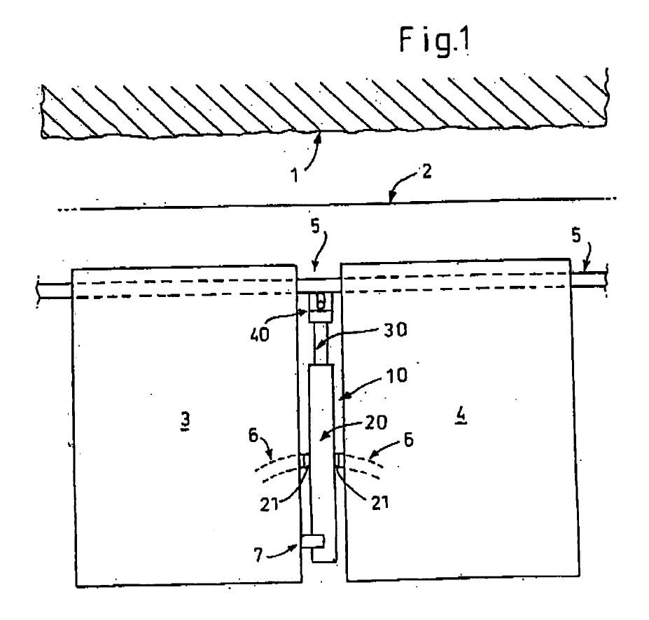

FIG. 1 shows diagrammatically a mining longwall with a conveyor and with two shield-type supports from above, between which supply line according to the invention is fastened to the conveyor;

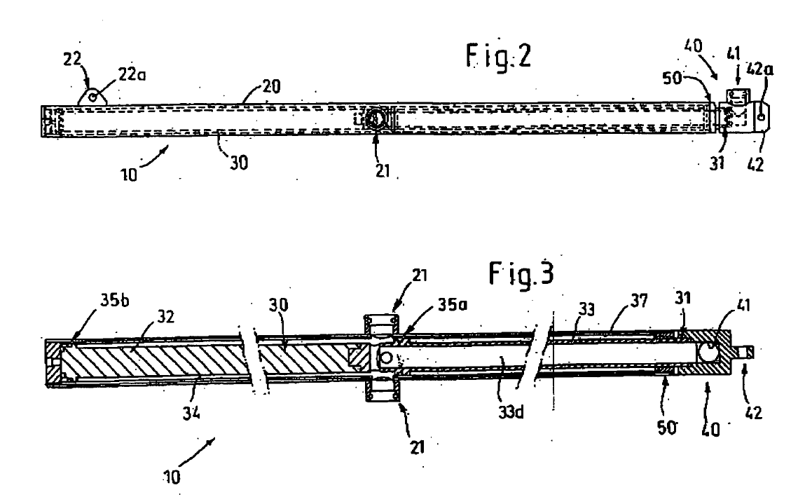

FIG. 2 shows a supply line according to the invention in side view;

FIG. 3 shows a horizontal section through the supply line from FIG. 2;

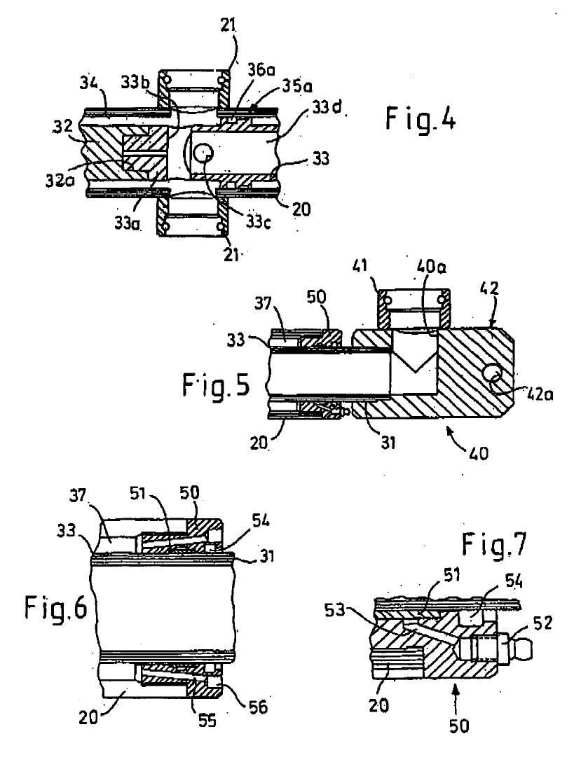

FIG. 4 shows in section a view of a detail of the supply line at the advancing support connections;

FIG. 5 shows a vertical section through a view of a detail of the angle cuff connected to the piston tube;

FIG. 6 shows a vertical section through a view of a detail of the conveyor-side guide sleeve; and

FIG. 7 shows a view of a detail of the guide sleeve from FIG. 6.

FIG. 1 shows diagrammatically a working face 1 of an underground mining longwall, with a conveyor 2 which runs parallel to said working face and past which a plow, not illustrated, travels in order to extract the mining material. A left support unit 3 and a right support unit 4 of the advancing support supporting the slope end are secured to the conveyor 2 by means of hydraulic bushing cylinders, not illustrated, in order to push the conveyor 2 forward during the progress of the mining work at the working face 1. For the hydraulic supply of the individual support units 3, 4 of the advancing support, a supply system 5 is led along on the packing side, facing away from the working face 1, of the conveyor 2, said supply system consisting of individual longwall lines, not illustrated, which provide the hydraulic medium by means of which, for example, the hydraulic rams of the support units and other hydraulic assemblies are actuated. The connection of the supply system 5 to the two support units 3, 4 takes place via a supply line 10 according to the invention, which consists essentially of a cylinder tube 20 and of a piston arrangement 30 guided telescopically in the cylinder tube 20.

The supply system 5 is connected via an angle cuff 40 plugged onto the piston arrangement 30 on the conveyor side, and the connection of the support units 3, 4 takes place via two nipples 21 which are arranged centrally between the two ends of the cylinder tube 20 and from which hoses 6, merely indicated by FIG. 1, lead to the support units 3, 4. The cylinder tube 20 is buttresses on the support unit 3 by means of the securing 7 projecting laterally to the rear end of the support unit, so that, in the event of the relative displacements between the support unit 3 and the conveyor 2, the piston arrangement 30 is pushed into the cylinder tube 20 or is extended out of the cylinder tube 20, a supply of the support units 3 and 4 with hydraulic medium via the supply line 10 being ensured at any time.

FIGS. 2 and 3 show the supply line 10 in a state in which the piston arrangement 30 is pushed completely into the cylinder tube 20; the piston arrangement 30 is indicated in FIG. 2 merely by a dashed line inside the cylinder tube 20. At the conveyor-side end of the supply line 10, an angle cuff 40 is connected, which is plugged onto that end 31 of the piston arrangement 30 which projects out of the cylinder tube 20 and is fastened so as to be sealed off. A leg 42 having a bore 42a for the passage of a bolt is formed in one piece on the angle cuff 40, and by means of this leg the angle cuff 40 and, with it, the conveyor-side end of the piston arrangement 30 can be secured to the conveyor 2. Near the opposite end of the supply line 10, a second, triangular holding device 22 having a bore 22a is welded, upright, to the cylinder tube 20.

The piston arrangement 30 guided in the cylinder tube 20 consists of a solid piston rod 32 which is connected in series to a hollow piston tube 33. The piston rod 32 and the piston tube 33 have in this case the same outside diameter and are approximately of equal length, so that the advancing support connections 21 arranged centrally on the cylinder tube 20 are located in the vicinity of an end piece 33a of the piston tube 33 when the piston arrangement 30 is pushed completely into the cylinder tube 20. The end piece 33a connects the piston tube 33 to the piston rod 32 via a screw connection. The piston rod 32 has a smaller outside diameter than the inside diameter of the cylinder tube 20, so that an annular gap 34, which serves as part of the inner duct, is formed around the piston rod 32, since the two advancing support connections 21 arranged laterally on the cylinder tube 20 issue into the annular gap 34 at the end piece 33a. In the vicinity of the end piece 33a, on the outside of the piston tube 33, a first guide bush 35a is arranged around the piston tube 33 and delimits the annular gap 34 on the conveyor side. At the end of the piston rid 32 which lies opposite the end piece 33a, a second guide bush 35b is arranged around the piston rod 32 and delimits the annular gap 34 on the advancing-support side. Between the piston tube 33 and the cylinder tube 20 is formed an annular cavity 37 which is delimited, on one side, by the guide bush 35a and, at the other end on the conveyor side, by the guide sleeve 50 inserted into the cylinder tube 20.

It can be seen clearly from FIG. 4 that the piston cavity 33d issues into the annular gap 34 via a radial bore 33c in the piston tube and via a transverse bore 33b in the end piece 33a. The adjoining end of the piston rod 32 is provided in a blind hole with an internal thread 32a which is screwed to an external thread of the end piece 33a of the piston tube 33. A sealing ring 36a bears against the guide bush 35a and seals off and consequently delimits the annular gap 34.

FIG. 5 shows the angle cuff 40 which is plugged onto the piston tube end 31 and to which an upwardly pointing nipple 41 as a feed connection is welded. It can be seen clearly that the leg 42 having the bore 42a is formed in one piece on the angle cuff 40. The piston tube 33 is surrounded by a guide sleeve 50 which closes the cylinder tube 20 on the conveyor side and which is shown in detail in FIGS. 6 and 7. The piston tube 33 is surrounded, so as to be sealed off, by the guide sleeve 50. The guide sleeve 50 received an annular and exchangeable guide element 51 which is preferably formed by a floating ring seal and which is supplied with a lubricant, not illustrated, via a lubricating nipple 52 and via a lubricant duct 53, in order to allow an easy sliding of the piston tube 33 in the guide sleeve 50. Furthermore, the guide sleeve receives a stripping ring 54 which prevents the penetration of foreign particles into the cylinder tube 20. Moreover, the guide sleeve 50 is provided with venting bores 55 which run at a slight inclination with respect to the axis of symmetry of the piston tube 33 and in each of which a filter may be arranged. The venting bores 55 serve for venting the air-filled annular cavity 37 during the telescopic movement of the piston arrangement 30 in the cylinder tube 20. The piston arrangement 30 is guided, supported at three points, in the cylinder tube 20 independently of the push-out state, to be precise via the guide bush 35b on the piston rod 32, via the guide bush 35a on the piston tube 33 and via the guide sleeve 50 on the cylinder tube 20.

Numerous modifications which should come within the scope of protection of the appended claims are evident from the description to a person skilled in the art. Alternatively, even only one advancing support connection may be arranged on the cylinder tube. The advancing support connections may also be arranged, upright or eccentrically, on the cylinder tube.

1-15. (canceled)

16. A supply line for connecting a hydraulic advancing support to a hydraulic supply system led along a conveyor, the supply line comprising:
a feed connection connected to the supply system;
a cylinder tube having a first end and a second end;
at least one advancing support connection located on the cylinder tube and a predetermined distance from the feed connection;
a telescopeable piston arrangement located within the cylinder tube; and
a variable length inner duct including at least a portion of the piston arrangement and the cylinder tube, the inner duct being operable for connecting the feed connection and the advancing support connection.

17. The supply line of claim 16, wherein the piston arrangement comprises:
a solid piston rod having a first end and a second end; and
a hollow piston tube having a first end and a second end connected in series with the piston rod; and
the piston arrangement is displaceable within the cylinder tube.

18. The supply line of claim 17, further comprising:
an end piece located on the second end of the piston tube;
an external thread located on the end piece; and
an internal thread located on the first end of the piston rod, wherein
the external thread is connected to the internal thread.

19. The supply line of claim 17, wherein
an outer diameter of the piston rod is less than an inner diameter of the cylinder tube;
an annular gap is located between an outer surface of the piston rod and an inner surface of the cylinder tube; and
at least a portion of the annular gap is included in the inner duct.

20. The supply line of claim 19, wherein
the piston tube includes a connecting port and a tube cavity;
the tube cavity forms a portion of the inner duct; and
the inner duct is connected with the annular gap via the connecting port.

21. The supply line of claim 16, wherein
the at least one advancing support connection is located substantially equidistant from the first and second ends of the cylinder tube.

22. The supply line of claim 20, wherein
a first advancing support connection and a second advancing support connection are located on the cylinder tube;
the first and second advancing support connections are connected with the annular gap; and
each of the first and second advancing support connections include at least one nipple.

23. The supply line of claim 19, further comprising:
a first guide bush located at the second end of the piston tube;
a first seal located on the first guide bush;
a second guide bush located at the second end of the piston rod;
a second seal located on the second guide bush, wherein
the first and second guide bushes delimit the annular gap.

24. The supply line of claim 17, further comprising a guide sleeve surrounding the piston tube, wherein
the first end of the cylinder tube is closed by the guide sleeve.

25. The supply line of claim 24, further comprising a floating seal located on the guide sleeve.

26. The supply line of claim 24, further comprising a lubricating nipple one of inserted into or integrated into the guide sleeve.

27. The supply line of claim 24, further comprising a stripping ring located within the guide sleeve and around the piston tube.

28. The supply line of claim 24, further comprising:
a venting bore located within the guide sleeve; and
a filter piece located within the venting bore.

29. The supply line of claims 17, further comprising an angle cuff, wherein
the first end of the piston tube is inserted into the angle cuff; and
the angle cuff is operable to seal the first end of the piston tube.

30. The supply line of claim 29, further comprising:
a first holding device, the first holding device including a conveyor fastening element and being located on the angle cuff; and
a second holding device, the second holding device including an advancing support fastening element and being located adjacent to the second end of the cylinder tube opposite the angle cuff.
